(19) United States
(12) Patent Application Publication
(10) Pub. No.: US 2026/0349680 A1
(43) Pub. Date: Nov. 5, 2026

(54) GENERATING, VALIDATING, AND EXECUTING CODE THAT ADHERES TO A CONSTRAINT SYSTEM

(71) Applicant: Goldman Sachs & Co. LLC, New York, NY (US)

(72) Inventor: Giovanni Faonte, Jersey City, NJ (US)

(21) Appl. No.: 19/347,222

(22) Filed: Oct. 1, 2025

Related U.S. Application Data
(63) Continuation of application No. 19/199,199, filed on May 5, 2025.

(51) Int. Cl. G06F 8/35

(52) U.S. Cl. CPC G06F 8/35

(57) ABSTRACT

The system and methods described herein enable generating and executing computer code payloads that adhere to a constraint system in a programming environment. The technique includes receiving a request for a data structure, accessing related data segments and computer code templates, and then applying a model to generate a computer code payload that will generate the requested data structure while adhering to the constraint system of the network system. The method also involves validating the generated code payload and then transmitting it to a system for execution. The system uses computer resources that adhere to the constraint system.

### CROSS REFERENCE TO RELATED APPLICATIONS

This application is a continuation of co-pending U.S. application Ser. No. 19/199,199, filed May 5, 2025, which is incorporated by reference in its entirety.

### FIELD OF DISCLOSURE

The present invention relates generally to the field of generating code using models, and, more specifically, to generating, validating, and executing computer codes that adhere to a given constraint system in a programming environment.

### BACKGROUND

High-level programming languages have enabled the creation of complex software applications and systems, but the diversity of programming languages and environments and the uniqueness of individual applications pose significant challenges in code generation. Due to the special circumstances of individual environments or programming languages, automatically generated code by Large Language Models (LLMs) is often not suitable for use without modification. Even small deviations from standards and rules established by individual systems can have a major impact on functionality, efficiency, compliance, and security.

Typically, constraints vary significantly across different system architectures and use-case scenarios, making it tedious for developers and businesses to have uniquely crafted rule mechanisms in place. This, along with potential discrepancies in the generated computer code related to individual system constraints, increases the overall complexity and time taken to develop a reliable, efficient, and compliant program.

Despite the advancements in programming languages and development methodologies, current techniques for managing system constraints in code generation and execution are often manual, inefficient, and error-prone. Existing approaches largely rely on careful manual review or complex error handling and debugging, often leading to unoptimized and delayed outcomes. Therefore, a solution is needed that can seamlessly and efficiently handle the generation, validation, and execution of computer code payloads.

### SUMMARY

In some aspects, the techniques described herein relate to a method for generating a computer code payload in response to receiving a request for a data structure, the method including: receiving, at a network system, a request to generate a computer code package, the request including a natural language request for a data structure generated by the computer code package; accessing a plurality of data segments related to the requested data structure based on a content and a context of the natural language request; accessing a plurality of computer code templates based on the content and context of the natural language request, each computer code template of the plurality providing a functionality related to generating to the requested data structure and adhering to a constraint system of the network system; generating a template query vector, the template query vector a representation of the requested data structure, each computer code template, and each data segment based on the content and the context of the natural language request; applying a model to the template query vector to select a computer code template of the plurality that generates the requested data structure based on the content and context of the natural language request, the plurality of computer code templates, and the plurality of data segments; generating, using the model applied to the selected computer code template and the plurality of data segments, the computer code payload that generates the requested data structure, wherein the computer code payload, when executed by the network system, adheres to the constraint system of the network system.

In some aspects, the techniques described herein relate to a method, further including: generating a code query vector, the code query vector a representation of the selected computer code template, the requested data structure, and each data segment; and wherein generating the computer code payload applies the model to the generated code query vector.

In some aspects, the techniques described herein relate to a method, further including: executing the computer code payload to generate the requested data structure; and providing the requested data structure to a device requesting the data structure.

In some aspects, the techniques described herein relate to a method, wherein accessing the plurality of computer code templates includes: generating a request vector representing functionality of the requested data structure; and comparing the request vector to vectors representing functionality of computer code templates in a template library; and selecting, based on a vector comparison, the plurality of computer code templates from computer code templates in the template library having vectors similar to the request vector.

In some aspects, the techniques described herein relate to a method, wherein accessing the plurality of data segments related to the requested data structure includes: generating a data request vector representing data used to generate the requested data structure; and comparing the data request vector to vectors representing data segments in a data segment library; and selecting, based on a vector comparison, the plurality of data segments from the data segment library having vectors similar to the data request vector.

In some aspects, the techniques described herein relate to a method, further including: accessing the selected computer code template from a template library; and providing the selected computer code template to the model for generating the computer code payload.

In some aspects, the techniques described herein relate to a method, wherein the model is a large language model.

In some aspects, the techniques described herein relate to a method, wherein the constraint system defines a set of code libraries usable in the computer code payload to generate the requested data structure.

In some aspects, the techniques described herein relate to a method, wherein the constraint system defines a maximum execution time of the generated computer code payload.

In some aspects, the techniques described herein relate to a method, wherein the constraint system defines a set of system resources usable by the computer code payload to generate the requested data structure.

In some aspects, the techniques described herein relate to a method for executing a computer code payload to generate a data structure in response receiving a request to generate the data structure, the request including natural language requesting the data structure, and the method including: generating, at a network system, the computer code payload by applying a code generation model to the natural language of the request for the data structure; validating, at the network system, the computer code payload is configured to execute within a constraint system of the network system; in response to validating the computer code payload, transmitting, to a system executing a selected set of computer resources adhering to the constraint system, the computer code payload for execution; instantiating, at the system executing the selected set of computer resources, one or more execution nodes, each of the execution nodes configured to execute computer code while adhering to the constraint system of the network system; executing, using the instantiated one or more execution nodes on the selected set of computer resources, the computer code payload to generate the data structure; validating that the generated data structure adheres to the constraint system; and in response to validating the generated data structure, providing, to the network system, the requested data structure.

In some aspects, the techniques described herein relate to a method, further including: generating an allocation schema for executing the computer code payload on the system, the allocation system defining the selected set of computer resources from a plurality of computer resources on the system.

In some aspects, the techniques described herein relate to a method, wherein validating the computer code payload includes: creating a temporary environment to execute the computer code payload; and executing the computer code payload in the temporary environment.

In some aspects, the techniques described herein relate to a method, wherein the temporary environment is configured to replicate the constraint system.

In some aspects, the techniques described herein relate to a method, wherein the temporary environment isolates the execution from system resources of the network system.

In some aspects, the techniques described herein relate to a method, further including: validating that the generated data structure is the data structure requested by applying a model to compare the generated data structure to the requested data structure.

In some aspects, the techniques described herein relate to a method, wherein the constraint system defines a set of code libraries usable in the computer code payload to generate the data structure.

In some aspects, the techniques described herein relate to a method, wherein the constraint system defines a maximum execution time of the generated computer code payload.

In some aspects, the techniques described herein relate to a method, wherein the constraint system defines a set of system resources usable by the computer code payload to generate the data structure.

The methods described herein may be implemented by computer program instructions stored on a non-transitory computer-readable storage medium. The computer program instructions, when executed by one or more processors, may cause the one or more processors to execute the computer program instructions and perform the method.

The methods described herein may be implemented on a system. The system may include a non-transitory computer readable storage medium and one or more processors. The non-transitory computer-readable storage medium stores computer program instructions for implementing the method. The computer program instructions, when executed by the one or more processors, may cause the one or more processors to execute the computer program instructions and perform the method.

### BRIEF DESCRIPTION OF DRAWINGS

FIG. 1 illustrates a system environment for generating, executing, and validating code adhering to a constraint system, according to an example embodiment.

FIG. 2 illustrates an example client device that may be used to interact with the network system, according to an example embodiment.

FIG. 3 illustrates a generation module, according to an example embodiment.

FIG. 4 illustrates an execution module, according to an example embodiment.

FIG. 5 is a workflow diagram of a generation module generating code adhering to a constraint system, according to an example embodiment.

FIG. 6 is a workflow diagram of a validation module validating generated code, according to an example embodiment.

FIG. 7 is a workflow diagram of an execution module executing code adhering to a constraint system, according to an example embodiment.

FIG. 8 is a workflow diagram for generating a computer code payload in response to receiving a natural language request for a data structure, according to an example embodiment.

FIG. 9 is a workflow diagram for generating a computer code payload in response to receiving a natural language request for a data structure, according to an example embodiment.

FIG. 10 is a block diagram illustrating components of an example machine for reading and executing instructions from a machine-readable medium, according to an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### I. Introduction

The use of Large Language Models (LLMs) in generating computer code has become a common tool in the realm of software development and programming environments. These LLMs offer compelling benefits to both non-technical and technical personnel alike. For the non-technical user, LLMs serve as a bridge, translating simpler, human-readable commands into intricate system-level instructions-a tool that democratizes programming to an even broader audience. Meanwhile, seasoned programmers utilize LLMs to optimize process efficiency and code productivity, allowing for more complex tasks to be performed with reduced manual programming.

However, a pivotal problem with LLMs resides in their predisposition to generate “sufficiently working” code without ample consideration for the specific system environments on which the code is intended to run. Irrespective of their viability, efficiency or perceived optimization, determining the suitability of such code within the given system framework often takes a backseat-resulting in potential mismatches between the generated code and system-specific requirements or constraints.

Indeed, in systems characterized by rigorous regulatory restrictions and parameters, such as those commonly found in security-sensitive, legally-bound, or financial infrastructures, the generated code's broad-spectrum performance characteristics and capabilities may result in non-compliance with the stringent system constraints that are in place. The projected emphasis on code viability, without deliberate consideration of the system's regulatory framework, makes the generated code a probable mismatch in these highly constrained environments.

Moreover, even in scenarios where the LLMs purportedly generate code intended to comply with a specific constraint system, the resultant code's actual validity could remain dubious, often leading to a lack of verifiable compliance. The absence of a reliable method for confirming adherence to the stipulated constraints, coupled with the inevitable complexity and variability of code generated by LLMs, results in an uncertainty gap that could prove detrimental in regulated environments.

Therefore, there is an evident need for a methodology that not only allows code generation by LLMs suitable for execution within restrictive constraint systems, but also provides a mechanism to verify the generated code's genuine adherence to these constraints. The lack of such strategies poses substantive risks and uncertainties, underscoring the need for enhanced ways of utilizing LLMs to generate reliable code, and verify that code is suitable within heavily monitored and highly regulated system environments. A system and method for remedying these problems are described herein.

### II. System Environment

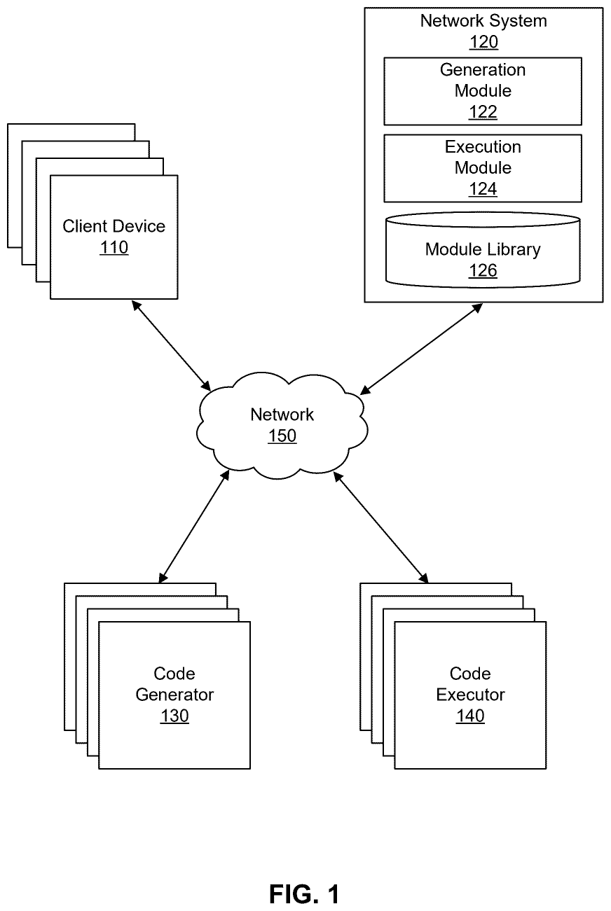

FIG. 1 illustrates a system environment for generating, executing, and validating code adhering to a constraint system, according to an example embodiment. In the illustrated example, the system environment 100 includes a client device 110, a network system 120, an code generator 130, a code executor 140, and a network 150. The network system 120 includes a generation module 122, an execution module 124, and a module library 126. The system environment 100 may include one or more client devices 110 (e.g., 1, 2, 3, 5, . . . , N client devices), include one or more code generator 130 (e.g., 1, 2, 3, 5, . . . , N systems), and include one or more code executor 140 (e.g., 1, 2, 3, 5, . . . , N systems). Some embodiments of system environment 100 have different systems and modules than those described herein. Similarly, functions of the systems and modules can be distributed within the system environment 100 in a different manner than is described herein.

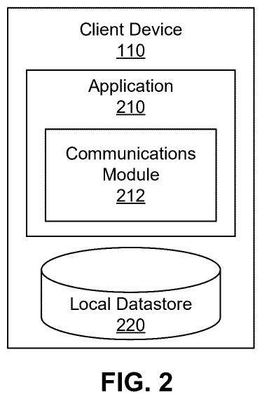

The client device 110 can be any computing device configured to interact with the query module 122. Although FIG. 1 shows several client devices 110, the system environment 100 may include any number of such devices. The client devices 110 present one or more user interfaces via which users may generate query requests and view query responses. Various embodiments of the client devices 110 and user interfaces are described in greater detail below, with reference to FIG. 2.

The network system 120 receives a request to generate a data structure from a client device 110 and generates the requested data structure in response. Typically, the request includes a natural language description of the desired data structure, or a natural language description of functionality provided by the data structure. For example, the request may be “Generate a time series diagram of Metric A over the past year for both Entity A and Entity B,” or “Generate an function that compares Metric A over the past year for both Entity A and Entity B.” In the first case, the requested data structured is the data plot including information in the request, and, in the second case, the requested data structure is an, e.g., executable that will generate the data plot.

Network system 120 employes generation module 122 to generate and validate, code that, when executed, generates the requested data structure. When generating and validating code to generate the requested data structures, generation module 122 ensures that those processes adhere to the constraint system of, e.g., network system 120. The constraint system of network system 120 is one or more constraints imposed on generation, validation and execution of code within system environment 100. Constraints may indicate, e.g., a restriction on computational systems the execution may employ, a limitation on run-time of the executing code, a constraint on the code libraries and modules allowed for use within system environment 100, etc. There can be many different constraint systems, and the constraint system applied may be based on, e.g., a global constraint system, the type of data structure requested, available computational resources in system environment 100, a constraint system provided by, e.g., a user of client device 110, etc.

Additionally, network system 120 employs execution module 124 to execute generated and validated code to generate the requested data structure. Network system 120 may execute generated code on code executor 140 according to an allocation schema. An allocation schema is some distribution and/or allotment of computational resources that ensures the executed code adheres to the constraint system of network system 120. For example, the allocation schema may define and load the appropriate code libraries, ensure runtimes less than a threshold runtime (e.g., by using more resources), use monitored and safe computational elements, instantiate safeguarded or sandboxed execution nodes, etc. There can be many different allocation schemas, and the allocation schemas may be based on, e.g., a global constraint system, the type of data structure requested, available computational resources in system environment 100, etc.

Additionally, network system includes a module library 126 storing one or more modules. A module may be, e.g., computer code or libraries that adhere to the constraint system of the network system 120. In other words, module library 126 stores computer code or libraries that have been previously validated and verified within the network system 120 and are known to be safe for execution giving the nature of information in the system environment 100. In some cases, the module library 126 may store one or more module templates. A module template is, e.g., a template of computer code that can be modified to generate data structures. Because the module templates are in the module library 126, computer code payloads generated from the module templates (e.g., by code generator 130) will adhere to the constraint system of the network system 120.

The description now provides a brief example of the generation and execution process. Network system 120 receives a request to generate a data structure. Generation module 122 leverages code generator 130 to identify a code template for generating code that, when executed, generates the requested data structure. Generation module 122 leverages code generator 130 to generate the code using the identified template. Generation module 122 validates the code to ensure it adheres to the constraint system of network system 120. Execution module 124 generates an allocation schema for the generated code and leverages code executor 140 to execute the generated code according to the allocation schema. Executing the generated code generates a data structure. Execution module 124 validates that the generated data structure is the requested data structure. The allocation schema ensures that the code execution on code executor 140 adheres to the constraint system of network system 120. Network system 120 provides the requested data structure to the requestor. This process is described in greater detail hereinbelow.

A code generator 130 is one or more systems or databases configured to generate code adhering to the constraint system of the network system 120. The code generator 130 may be an enterprise system comprising one or more systems or databases connected to the network system 120 within the system environment 100, or may be a system internal to the network system 120 (not shown). Code generator 130 is typically a model configured for generating code according to instructions and adhering to the constraint system of network system 120. With this context, code generator 130 may input a request to select a module for generating code that, when executed, generate the requested data structure and output a module responsive to that request. Similarly, code generator 130 may input a request to generate code according to a module template and outputs code adhering to the module template. The generated code, when executed, generates the requested data structure in a manner that adheres to the constraint system.

In an embodiment, code generator 130 is a large language model. The large language model may be a generative pre-trained transformer architecture, or some other model for configured for generating code. For the pre-trained transformer configuration, code generator 130 may instantiate a context window for the LLM that is configured for (1) identifying modules to act as template for generating code that, when executed, generates the requested data structure and (2) generating code using a template that, when executed, generates the requested data structure. In this case, code generator 130 can receive one or more prompts tailored to aid in selecting those modules or generating that code.

A code executor 140 is one or more systems or databases configured to execute generated code while adhering to the constraint system of network system 120. The code executor 140 may be an enterprise system comprising one or more systems or databases connected to the network system 120 within the system environment 100, or may be a system internal to the network system 120 (not shown). The code executor 140 may include one or more computational elements configured for executing code such as, e.g., a Kubernetes node arrays, managed cloud execution services, batch schedulers and their corresponding processors, execution orchestrators, etc. Whatever the hardware implementation, code executor 140 is configured to scale and adapt its resources to effectively execute code generated by code generator 130 such that its execution adheres to the constraint system of network system 120. For instance, code generator may be configured to execute generated code using an allocation schema which indicates how to allocate system resources for the code execution.

As shown in FIG. 1, client device 110, network system 120, code generator 130, and code executor 140 are in communication with one another via a network(s) 150. In one embodiment, the network 150 is the Internet or any combination of a LAN, a MAN, a WAN, a mobile, wired or wireless network, a private network, or a virtual private network. The network 150 provides the communication channels via which the other elements of the networked computing environment 100 communicate. The network 150 can include any combination of local area and wide area networks, using wired or wireless communication systems. In one embodiment, the network 150 uses standard communications technologies and protocols. For example, the network 150 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, some or all of the communication links of the network 150 may be encrypted using any suitable technique or techniques.

### Client Device

FIG. 2 illustrates an example client device that may be used to interact with the network system, according to an example embodiment. In the illustrated example, the client device 110 includes an application 210 (“app”) and a local datastore 220. In other embodiments, the client device 110 includes different or additional elements. In addition, the functions may be distributed among the elements in a different manner than described.

The application 210 is software that executes on the client device 110 to enable interaction with the network system 120. The application 210 may include a communications module 212. The communications module 212 sends data structure requests to the network system 120 over the network 150 and receives/processes data structures received from the network system 120 in response. The local datastore 220 includes one or more computer-readable media that store the data used by the client device 110. For example, the local datastore 220 may include cached copies of data used in generating query requests and/or query responses. Generation Module As described above, network system 120 includes generation module 122. The generation module 122 receives a request to generate a data structure (e.g., a graph) from a client device 110 via the network 150 and sends the data structure to the client device 110 via the network 150 in response.

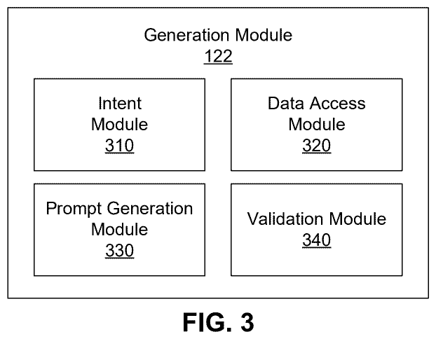

FIG. 3 illustrates a generation module, according to an example embodiment. In the embodiment shown, the generation module 122 includes an intent module 310, a data access module 320, a prompt generation module 330, and a validation module 340. In other embodiments, the generation module 122 includes different or additional elements. At a high level, generation module 122 receives a request from client device 110 to generate a data structure and generates executable code that, when executed in system environment 100, generates the requested data structure. Additionally, functions of the generation module 122 may be distributed among the elements therein in a different manner than described, and/or the functions may be distributed within the system environment 100 in a different manner than described.

Generation module 122 includes intent module 310. Intent module 310 processes natural language of the request to identify information contextually and intentionally relevant to generating code that, when executed, generates the requested data structure. To illustrate, consider again the example request, “Generate a time series of Metric A over the past year for both Entity A and Entity B.” Intent module 310 may process the natural language of the request to identify that the plot should include data for Metric A, relay information about Entity A and Entity B, have a time window for data of the past 12 months. Intent module 310 may identify the relevant information by processing the request with, e.g., a language model such as a large language model. In this case, the large language model creates a vector representation of the natural language request and extracts the relevant information. In some cases, intent module 310 may generate one or more prompts to configure a context window for the large language model for identifying relevant information for code generation.

Additionally, intent module 310 processes the natural language of the request to identify one or more modules from module library 126 that may, when executed, generate the requested data structure. To do so, intent module 310 may process language of the request to identify functionality contextually and intentionally relevant for generating code that, when executed, generates the data structure. To illustrate, continuing the example from above, intent module 310 identifies that the requested data structure is an x vs y plot with the x axis being a time axis. Intent module 310 uses the determined relevant functionality to identify modules in module library 126 that may provide that functionality. To do so, intent module 310 may generate a vector representing the relevant functionality and compare that vector to vectors representing the functionality of each module in the module library (e.g., by cosine similarity).

For example, again continuing the example, the intent module 310 may identify all modules in module library 126 that have a time-series x-axis and a y-axis for describing metrics. Some example relevant modules may include, e.g., “day-by-day time series comparison plot,” “relative change over time graph,” “monthly revenue and expenditures chart,” etc. As noted above, the identified modules all adhere to the constraint system of network system 120 because they are in module library 126.

Generation module 122 includes data access module 320. Data access module 320 is configured to access data relevant to generating the requested data object. Typically, data access module 320 inputs the relevant information identified by intent module 310 and accesses that information within system environment 100. For example, again using our previous example, data access module 320 may access quantitative or qualitative data describing Metric A for both Entity A and Entity B. Data access module 320 may also create a vectorized representation of the accessed data such that a representation of the data may be used in identifying modules (e.g., templates) for generating code, or generating code that uses the data as input.

Generation module 122 includes a prompt generation module 330. Prompt generation module 330 is configured to generate one or more prompts to assist code generator 130 in identifying modules for generating code and/or generating code that, when executed, generates the requested data structure. Prompt generation module 330 may generate prompts based on a variety of information with system environment 100, some examples of which are described herein.

For instance, prompt generation module 330 may generate prompts that include one or more data structures which configure code generator 130 for identifying modules for generating code and generating the code itself (e.g., tune its context window). For instance, one or more of the data structures in a prompt may be (1) a natural language structure that sets or modifies a context window for a large language model executing on code generator 130, (2) a natural language structure or vector structure that representing data relevant to the requested data structured, (3) a natural language structure or vector structure representing modules identified as having relevant functionality, etc. The data structures within the prompt tune the context window of language models in code generator 130 for identifying relevant modules and generating code. Additionally, prompt generation module 330 may generate a series of prompts (rather than a single prompt) to tune the context window of the code generator 130.

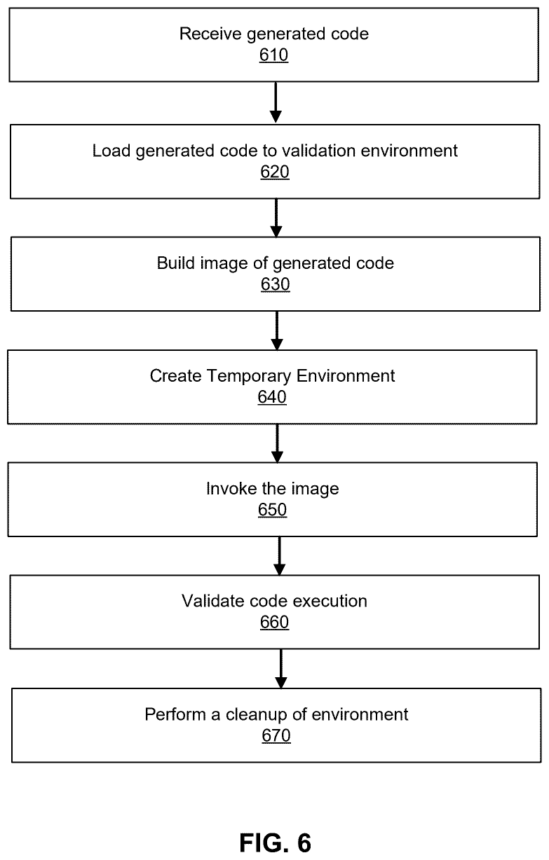

Generation module 122 includes validation module 340. Validation module 340 is configured to validate code generated by code generator 130. Validation module 340 validates code by ensuring the generated code, when executed in system environment 100, adheres to the constraint system of network system 120. An example of validation module 340 validating code generated by code generator 130 is described in regard to FIG. 6 below.

### Execution Module

As described above, network system 120 includes execution module 124. The generation module 122 receives a request to generate a data object (e.g., code) from a client device 110 via the network 150 and sends the data object to the client device 110 via the network 150 in response.

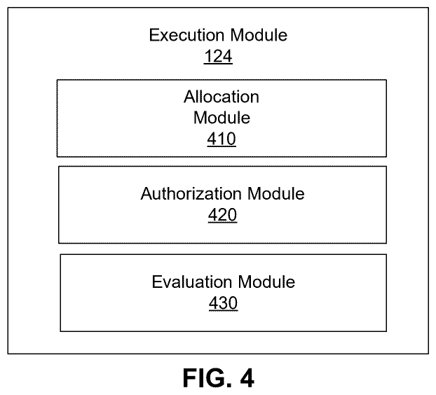

FIG. 4 illustrates an execution module, according to an example embodiment. In the embodiment shown, the execution module 124 includes an allocation module 410, an authorization module 420, and an evaluation module 430. In other embodiments, the generation module 122 includes different or additional elements. In addition, functions of the generation module 122 may be distributed among the elements in a different manner than described, and/or the functions may be distributed within the system environment 100 in a different manner than described. For example, functionality of allocation module 410 may be performed by code executor 140.

Execution module 124 includes allocation module 410. Allocation module 410 is configured to allocate resources within system environment 100 (e.g., at code executor 140, network system 120, etc.) to execute code generated by code generator 130 and validated by network system 120. As described above, network system 120 executes code according to an allocation schema. The allocation schema refers to how computational resources (e.g., computational nodes, processing systems, memory, etc.) are allocated to execute the generated code. Notably, allocation module 410 generates an allocation schema that ensures the generated code is executed within system environment 100 according to the constraint system of network system 120. There are many factors in generating an allocation schema that adheres to a constraint system, some of which are described hereinbelow.

In an example, consider a constraint system that includes limitations on which computational resources are allowed to execute the generated code. In this case, the allocation schema for the generated code may allocate the system resources for executing the code, and the only allocated resources are those adhering to the limitations of the constraint system. For example, the constraint system may define that generated code is only executable in computationally isolated environments, and allocation module 410 generates an allocation schema that defines the computational environments for the generated code to be executed within.

In an example, consider a constraint system that includes limitations on a maximum allowable length for executing the generated code. In this case, the allocation schema for the generated code may allocate the system resources for generating the executed code in a manner that ensures the processing time is less than the maximum allowable lengths. For example, the constraint system may define that generated code must be executed in less than, e.g., 30 s. The allocation module 410 generates an allocation schema that allocates sufficient resources to executing the code (e.g., instantiates a sufficient number of processing nodes) to complete execution in less than the maximum allowable time.

In an example, consider a constraint system that includes limitations on the of executed code itself (e.g., languages, modules, inputs, outputs, access, etc.). In this case, the allocation schema for the generated code may allocate system resources to the generated code in a manner that adheres to the code limitations. For example, the constraint system may define that only certain libraries may be used when executing the generated code. In turn, allocation module 410 generates an allocation schema that prevents system environment 100 from allocating libraries outside of the constraint system. Similarly, the constraint system may define that only certain types and sources of input may be used when executing the generated code. In this case, allocation module 410 generates an allocation schema that ensures only the allowed types of data are used during execution of the generated code.

Other examples of allocation module 410 generating an allocation schema are also possible. Moreover, the allocation module may generate allocation schema that adhere to constraint systems having more than one and different constraints.

Execution module 124 includes authorization module 420. Authorization module 420 is configured for authorizing and authenticating requesting elements within network system 120. Recall again that, typically, network system 120 stores and processes sensitive information. As such, one or more aspects of network system 120 may be logically or locationally isolated from one another for privacy or security reasons. As such, execution module 124 includes functionality network system 120 that ensures that executing generated code with system environment 100 adheres to whatever security protections may exist. For example, if a user requests a data structure showing Metric A for Entity A, authorization module 420 may authenticate that the requesting user has access to information to related to Entity A, Metric A, or has access to the requested computation resources, etc. Authorization module 420 can use any authentication methods known in the art.

Execution module 124 includes evaluation module 430. Evaluation module 430 is configured for executing the generated code according to the allocation schema such that, when executed, to generated code adheres to the constrain system. To do so, evaluation module 430 may provide the generated code to, e.g., code executor 140 and receive the requested data structure in response. In some cases, evaluation module 430 directly executes the generated code on resources of network system 120.

Additionally, evaluation module 430 may be configured to verify that the generated data structure is responsive to the requested data structure. That is, evaluation module 430 may determine whether the generated data structure is the requested data structure. To do so, evaluation module 430 may employ one or more machine learned models to determine if the generated data structure is the requested data structure. For example, evaluation module 430 may input the natural language request for the data structure and the generated data structure into a large multi-modal model, and the large multi-modal model may generate an output representing whether the generated data structure is the requested data structure. In some cases, much like prompt generation module 330, evaluation module 430 can generate one or more prompts for the model to assist in this validation process. The prompts can include any of the additional information to aid in setting the context window of the multi-modal model described herein.

Moreover, evaluation module 430 may be configured to verify that the generated data structure adheres to the constraint system of the network system 120.

### III. Example Workflows

### First Example Workflow

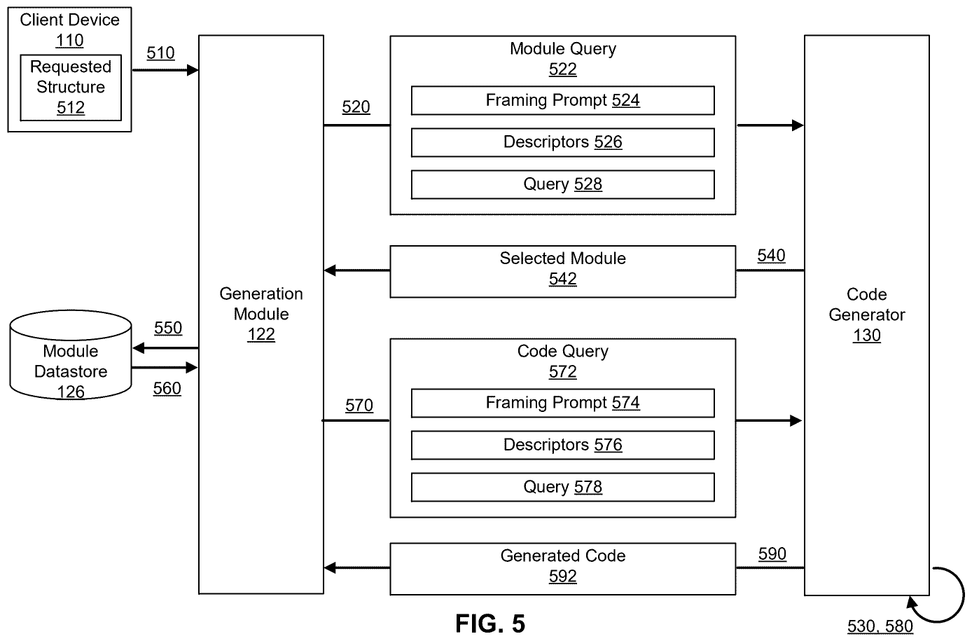

As noted above, network system 120 includes generation module 122, and generation module 122 is configured to generate and validate code adhering to a constraint system. FIG. 5 is a workflow diagram of a generation module generating code adhering to a constraint system, according to an example embodiment.

At 510, a client device 110 generates a request to generate a data structure (e.g., requested data structure 512). The request may include a natural language description of the requested data structure 512. For example, the request may be, “Please provide a plot that compares a first metric to a second metric.” The client device 110 transmits the request to the generation module 122 of the network system 120 via the network 150, and the generation module 122 receives the request.

Because network system 120 is a system environment 100 that is at high risk for compromise and includes sensitive information, any data structure 512 generated within the system environment 100 must adhere to a strict constraint system. The constraint system may include, e.g., white-listed data structures (e.g., code templates and libraries), allowable execution timeframes, allowable execution computational costs, allowable execution ports, systems, and elements, etc.

At 520, the generation module 122 generates a module query 522 based on requested structure 512 and transmits the module query 522 to the code generator 130. To do so, the generation module 122 may process natural language of the request for context and intent to generate module query 522. Generating the module query 522 may include generating a framing prompt 524, descriptors 526 (e.g., module descriptors, data descriptors, constraint descriptors), and a query 528. The generated module query 522 may be a data structure that includes the quantitative and/or qualitative of the information therein.

For the module query 522, framing prompt 524 is a prompt for a code generator 130 that modulates the context window for selecting a module for generating code withing the network system 120 that adheres to its constraint system (e.g., from module library 126). Module descriptors are quantitative or qualitative descriptions or representations of the various modules (e.g., APIs, code templates, etc.) that adhere to the constraint system of network system 120 (e.g., those stored in module library 126). Data descriptors are quantitative or qualitative descriptions or representations of data that may be used in generating the requested data object (e.g., data sets). Constraint descriptors are quantitative or qualitative descriptions or representations of various constraints to which the generated code (or selected module) must adhere. The query 528 is a prompt for a LLM configured to select a module that, when implemented, generates the requested data object (given the farming prompt and descriptors).

In this example, module query 522 provides a framing prompt 524 that sets the context window for selecting modules for generating the requested data structure 512. The descriptors provide descriptions of data pertaining to the requested data structure 512, the modules that may be used to respond to the request present in the module library 126, and any relevant constraint information. The query 528 is a natural language request to select a module from the described modules that can generate the requested data structure 512 given the constraints.

At 530, code generator 130 processes module query 522. That is, code generator 130 inputs module query 522 and selects a module that is most likely to generate the requested data structure 512 given the descriptors 526 and query 528. To expand, in an example where code generator 130 is an LLM, the LLM processes the content and content of the framing prompt 524, descriptors 526, and query 528 to determine the module most likely to generate the requested data structure 512 given the information therein.

At 540, the code generator 130 transmits the selected module 542 to generation module 122, and generation module 122 receives the selected module 542.

At 550, generation module 122 transmits a request for selected module 542 to the module library 126.

At 560, module library 126 provides selected module 542 to generation module 122 in response.

At 570, the generation module 122 generates a code query 522 based on the selected module 542 and transmits the code query 522 to the code generator 130. To do so, the generation module 122 may again process the natural language of the request from the client device 110 for context and intent given the selected module to generate code query 572. Generating the code query 522 may include generating a framing prompt 574, descriptors 576 (e.g., module descriptors, data descriptors, constraint descriptors), and a query 578. The generated code query 572 may be a data structure that includes the quantitative and/or qualitative information therein.

For the code query 572, framing prompt 574 is a prompt for a code generator 130 that modulates the context window for generating code using a selected module 542 that adheres to the constraints of the network system 120. Module descriptors are quantitative or qualitative descriptions or representations of the selected module (e.g., API, code templates, example inputs and outputs, etc.) that adhere to the constraint system of network system 120. Data descriptors are quantitative or qualitative descriptions or representations of data that may be used in generating the requested data object (e.g., data sets) 512. Constraint descriptors are quantitative or qualitative descriptions or representations of various constraints to which the generated code must adhere. The query 578 is a prompt for a LLM configured to generate code that generates the requested data structure 512 based on the framing prompt and the descriptors.

In this example, code query 572 provides a framing prompt 574 that sets the context window of the code generator 130 for generating code using a selected module 542 based on the descriptors (e.g., using the selected module as a template for specific code given the descriptors). The descriptors provide descriptions of data pertaining to the requested data object, the selected module 542 and its functions, input, and output, the selected module 542 itself or the location of the selected module 542for access, and any relevant constraint information. The query 578 is a natural language request to generate code that generates the requested data structure 512 using the selected module given the constraints.

At 580, code generator 130 processes code query 572. That is, code generator 130 inputs code query 572 and generates code using the selected module 542 that is likely to generate the requested data structure 512 given the descriptors 526 and query 528. To expand, in an example where code generator 130 is an LLM, the LLM processes the content and content of the framing prompt 524, descriptors 526, and query 528, and generates code (using the selected module 542 as a template) likely to generate the requested data structure 512 when executed in the environment 100.

At 590, code generator 130 provides the generated code 592 to the generation module 122. The generation module 122 may validate or execute the generated code 592.

Second Example Workflow As noted above, network system 120 includes validation module 340, and validation module 340 is configured to validate generated code. That is, validation module 340 is configured to determine whether generated code executes within system environment 100 and adheres to the constraint system. FIG. 6 is a workflow diagram of a validation module validating generated code, according to an example embodiment. The workflow may include additional or fewer steps and the steps may be performed in a different order. Moreover, one or more of the steps may be repeated depending on the configuration of system environment 100.

Network system 120 receives 610 or accesses generated code (e.g., generated code 592). For example, validation module 340 receives generated code generated by code generator 130 that is predicted to generate the requested data structure (e.g., requested data structure 512) when executed in system environment 100.

Validation module 340 loads 620 the generated code into a validation environment. Typically, the validation environment is a set of system resources within system environment 100 configured for safely validating code in an environment configured for determining whether the code adheres to the constraint system of system environment 100. For example, the validation environment may be a sandbox environment, a cloud system, an application or program configured for validating code, etc. Generally, the validation environment is configured to mirror or replicate the constraint system of the system environment 100 such that the validation process can evaluate whether the generated code adheres to the constraint system.

Validation module 340 builds 630 an image of the generated code. In this context, generating an image of the generated code refers to the process of creating a self-contained, executable binary or runtime environment from the received code. This process includes compiling the code, resolving dependencies, packaging necessary resources, and configuring the resulting executable in a format suitable for deployment or execution within a designated computing environment (e.g., the validation environment).

Validation module 340 creates 640 a temporary environment within the validation environment to execute the image. Creating the temporary environment provisions system resources in system environment 100 for the validation. The resources are transient and isolated configured to execute and test a specific code snippet, application, or process. This may involve allocating computational resources, setting up runtime dependencies, initializing configurations, and establishing a controlled context in which the functionality or behavior of the subject code can be validated. Specifically, the temporary environment is configured to test whether the generated code adheres to the constraint system.

Validation module 340 invokes 650 the image in the temporary environment.

Invoking the image initiates and executes the self-contained binary or runtime package within the temporary computing environment. This may involve loading the image into memory, initializing its runtime dependencies, and starting its execution to perform the tasks or operations defined by its contained code or configuration. The invocation process may include passing required input parameters, establishing connections to necessary services, and configuring the runtime context to ensure the image operates as intended.

Validation module 340 validates 660 the executed code. Validating the code, in general, determines whether the executed code adheres to the constraint system of system environment 100. In an example where the constraint system includes not executing code the exposes sensitive information (e.g., financial information, personal identification information, etc.), validating the code may include detecting sensitive information within source code, scanning code for patterns that resemble sensitive information, analyzing versions and file histories, analyzing inputs and outputs, performing a contextual analysis the preceding, etc.

Moreover, validating the code may include determining whether the executed code adheres to security standards of the system including access paths, build environments, etc. Many examples are possible.

In situations where validation module 340 determines the generated code adheres to the constraint system when executed in the validation environment, validation module 340 passes the generated code to execution module 124. In situations where validation module 340 determines the generated code does not adhere to the constraint system when executed in the validation environment, validation module 340 blocks the generated code from being executed. In some cases, generation module 122 may receive this information and attempt to generate code to the requested data object again, but using the information determined from the validation process to prevent the generated code from failing validation again (e.g., tailored prompts).

Validation module 340 performs 670 a cleanup of the environments. Validation module 340 cleans up the environments (e.g., temporary environment, validation environment) by restoring it to the original state. This may include deleting the temporary environment, removing resources from the validation environment, etc.

### Third Example Workflow

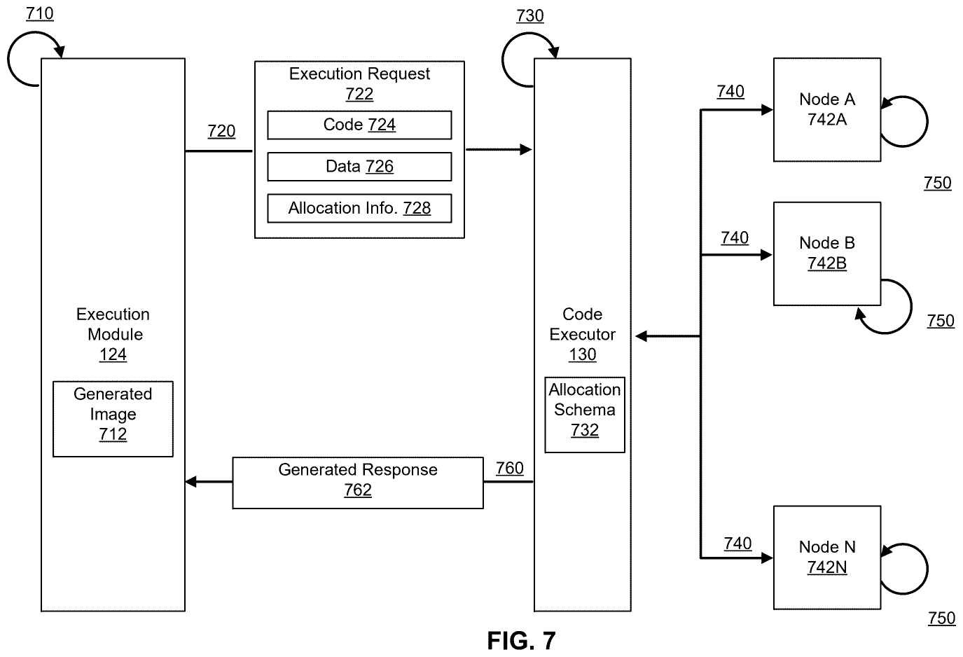

As noted above, network system 120 includes execution module 124, and execution module 124 is configured to execute and validate code adhering to a constraint system. FIG. 7 is a workflow diagram of an execution module executing code adhering to a constraint system, according to an example embodiment.

At 710, execution module 124 receives a generated image 712 from generation module 122. Generated image 712 is an executable image of code generated by generation module 122 configured for generating a data object requested by a client device (e.g., workflow of FIG. 5). Generated image 712 may have been validated for execution in system environment 100 (e.g., workflow of FIG. 6). As such, generated image 712 is suitable for execution in system environment 100 according to the constraint system.

Execution module 124 process generated image 712 to determine an allocation schema for executing generated image 712. An allocation schema is a quantitative and/or qualitative description of how the generated image 712 will be executed within system environment 100. For example, the allocation schema may define which elements of system environment 100 are suitable for executing generated image 712 (or some portion thereof), a number of elements to instantiate for execution, security measures to implement for executing the code, etc. Whatever the case, execution module 124 defines how the generated image 712 will be executed in system environment 100.

At 720, execution module 124 generates an execution request 722 and transmits execution request 722 to the code generator 130, and code generator 130/receives the execution request 722. Execution request 722 may include executable code 724, data 726, and allocation information 728 pertaining the generated allocation schema. Executable code 724 may be, for example, the generated image 712. In other examples, executable code 724 may be some other executable version of code generated by the generation module 122 (e.g., generated code 592) for generating the requested data object (e.g., requested data structure 512). Data 726 is any data relevant to the executable code 724. Data 726 may be, e.g., input data, for the executable code 724. Allocation information 728 is quantitative or qualitative representations of the allocation schema that, when implemented by code generator 130, execute executable code 724 according to that schema and the constraint system of system environment 100.

At 730, code generator 130 processes the execution request 722 to prepare executable code 724 for execution. To do so, code generator 130 may identify the allocation information 728 and prepare to implement the allocation schema 732 using its system resources. Moreover, code generator 130 may verify and authenticate any request to execute executable code 724 before doing so.

At 740, code generator 130 allocates system resources based on the allocation information 728 to implement the allocation schema. Doing so enables code generator 130 to execute executable code 724 according to the constraint system of system environment 100. In the illustrated example, allocating the system resources includes instantiating a first node 742A, a second node 742B, and an Nth node 742N. Each node may represent some subset of system resources responsible for executing all or some of executable code 724. For instance, first node 742A may be a first port on a first set of hardware, and second node 742B may be a second port on a second set of hardware. In another example, each node 742 may be a different segment of the same hardware set.

At 750, code generator 130 executes executable code 724 to generate a response. That is, code generator 130 executes executable code 724 according to the allocation schema using its system resources to generate a response. Typically, the response is the requested data object. To illustrate, as shown, first node 742A executes a first portion of executable code 724 and second node 742B executes a second portion of second node 742B. In another example, each node may execute the entirety of executable code 724. In some configurations, code generator 130 may process the responses generated by the execution to generate an aggregate response. For example, if portions of executable code 724 is executed across multiple nodes, code generator 130 may combine the responses from the nodes to generate an aggregate response. In another example, if executable code 724 is executed on multiples nodes, code generator 130 may select, combine, process, etc., the responses from each node to generate the aggregate response.

At 760, code generator 130 provides the generated response 762 to execution module 124. Code generator 130 may validate the generated response as discussed hereinabove.

Additionally, execution module 124 may provide the generated response (e.g., the requested data object) to the requesting client device 110.

### Fourth Example Workflow

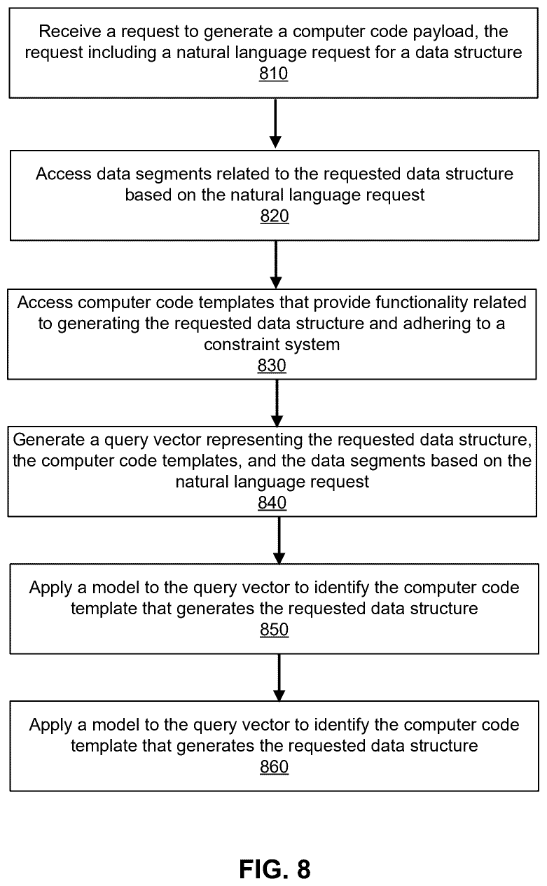

FIG. 8 is a workflow diagram for generating a computer code payload in response to receiving a natural language request for a data structure, according to an example embodiment.

The workflow 800 may include additional or fewer steps and the steps may be performed in a different order. Moreover, one or more of the steps may be repeated depending on the configuration of system environment 100.

In an example configuration, the workflow 900 is performed within a system environment (e.g., system environment 100). A client device (e.g., client device 110) generates a natural language request for a data structure (e.g., via user input) and transmits that request to a network system (network system 120). The network system is configured to generate a computer code payload that, when executed, would generate the requested data structure. The requested data structure may be, e.g., a graph comparing a metric of a first entity to the metric for a second entity over a time. Thus, the computer code payload, when executed by the network system, would generate the requested data object (e.g., the graph).

Importantly, the network system stores and processes sensitive information and, as such, any computer code packages executed therein must adhere to a rigid constraint system.

Various constraint systems are possible, but, generally, the constraint system limits information allowed in generated code payloads, systems accessible by generated code payloads etc.

The network system receives 810 the request to generate the computer code payload. The request includes the natural language request for the data structure. In some cases, the request may include information describing the constraint system, or the constraint system may be known withing the network system.

The network system (e.g., using a generation module 122) accesses 820 data segments related to the requested data structure. To do so, the network system may process the natural language of the request to determine what data segments are applicable for generating the requested payload. In this example, the data segments may be information related to the metric a and for the first entity and the second entity over the time period.

The network system (e.g., using generation module 122) accesses 830 computer code templates based on the content and content of the request. The accessed computer code templates are those templates that have a high probability of being related to, providing, or generating the requested data structure. The accessed computer code templates all adhere to the constraint system when executed. None of the accessed computer code templates fail to adhere to the constraint system.

The network system (e.g., using generation module 122) generates 840 a template query vector. The template query vector is a vectorized representation of the accessed data segments, computer code templates, and requested data structure. The template query vector is generated based on the content and context of the natural language request. In some cases, the template query vector may include additional information configured to set a context window of a code generation model (e.g., code generator 130).

The network system transmits the template query to code generator 130, and the code generator processes the template query. To do so, code generator 130 applies 850 a model (e.g., a large language model) to the template query vector. The large language model selects a computer code template that has a high probability of generating the requested data structure based on information in the template query vector (e.g., representations of data segments, context and intent of the request, code templates, etc.). Because all of the provide computer code templates do adhere to constraint system, the model selects a computer code template that adheres to the constraint system. Stated differently, because none of the templates diverge from the constraint system, the selected template adheres to the constraint system.

The network system generates 860 a computer code payload to create the requested data structured using the selected computer code template and the data segments. This process may include accessing the selected template and using the accessed template to create a code generation query for the model. See, e.g., FIG. 5. The generated computer code payload, when executed by the network system, generates the requested data structure.

### Fifth Example Workflow

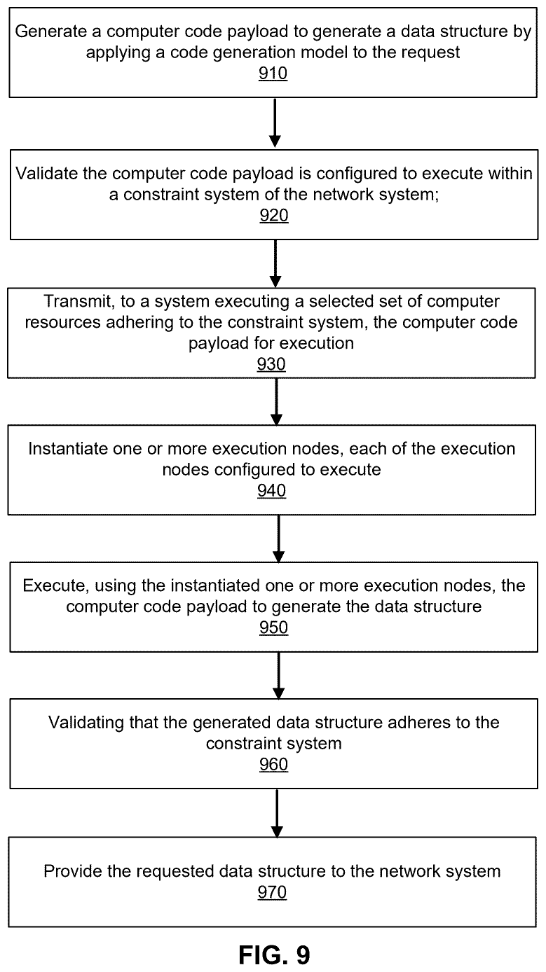

FIG. 9 is a workflow diagram for generating a computer code payload in response to receiving a natural language request for a data structure, according to an example embodiment.

The workflow 900 may include additional or fewer steps and the steps may be performed in a different order. Moreover, one or more of the steps may be repeated depending on the configuration of system environment 100.

In an example configuration, the workflow 900 is performed within a system environment (e.g., system environment 100). A client device (e.g., client device 110) generates a natural language request for a data structure (e.g., via user input) and transmits that request to a network system (network system 120). The network system is configured to generate a computer code payload that, when executed, would generate the requested data structure. The requested data structure may be, e.g., a graph comparing a metric of a first entity to the metric for a second entity over a time. Thus, the computer code payload, when executed by the network system, would generate the requested data object (e.g., the graph).

Importantly, the network system stores and processes sensitive information and, as such, any computer code packages executed therein must adhere to a rigid constraint system.

Various constraint systems are possible, but, generally, the constraint system limits information allowed in generated code payloads, systems accessible by generated code payloads etc.

The network system receives the request to generate the computer code payload. The request includes the natural language request for the data structure. In some cases, the request may include information describing the constraint system of the network system, or the constraint system may be known withing the network system. The network system generates 910 the computer code payload. The generated computer code payload, when executed, generates the requested data structure.

The network system validates 920 that the computer code payload is configured to execute within the constraint system of the network system. As described above, this validation can include generating a protected validation environment (e.g., a sandbox). Moreover, validation can mean testing that the computer code payload executes in under a threshold amount of time, using the appropriate modules, using the appropriate system resources, etc.

In response to validating the computer code payload, the network system transmits 930 the computer code payload to an execution system (e.g., code executor 140). The computer code payload includes system resources and configures a set of those system resources to adhere to the constraint system. In some cases, the execution system may generate an allocation schema that defines how system resources within the execution are allocated to execute the computer code payload according to the constraint system (e.g., selecting usable modules, processors, ports, etc.).

The execution system instantiates 940 one or more execution nodes to execute the computer code payload according to the allocation schema. Each execution node is some subset of system resources in the execution system that is configured to execute the computer code payload. Stated differently, the execution system allocates instantiates execution nodes according to the allocation schema such that the computer code payload, when executed, adheres to the constraint system.

The execution system executes 950 the computer code payload using the instantiated one or more execution nodes. Because the one or more execution nodes are configured to execute computer code according to the constraint system, the execute computer code is executed in a manner that adheres to the constraint system. Executing the computer code payload using the execution nodes generates the requested data structure.

The execution system validates 960 the generated data structure. Validating the generated data structure can mean validating that the generated data structure provides the same functionality as the requested data structure and/or validating that the generated data structure adheres to the constraint system of the network system.

In response to the validation, the execution system provides 970 the requested data structure to the network system. If the generated data structure fails validation, the execution system may prevent the data structure from being provided to the network system, generate a new data structure, etc.

### IV. Computer System

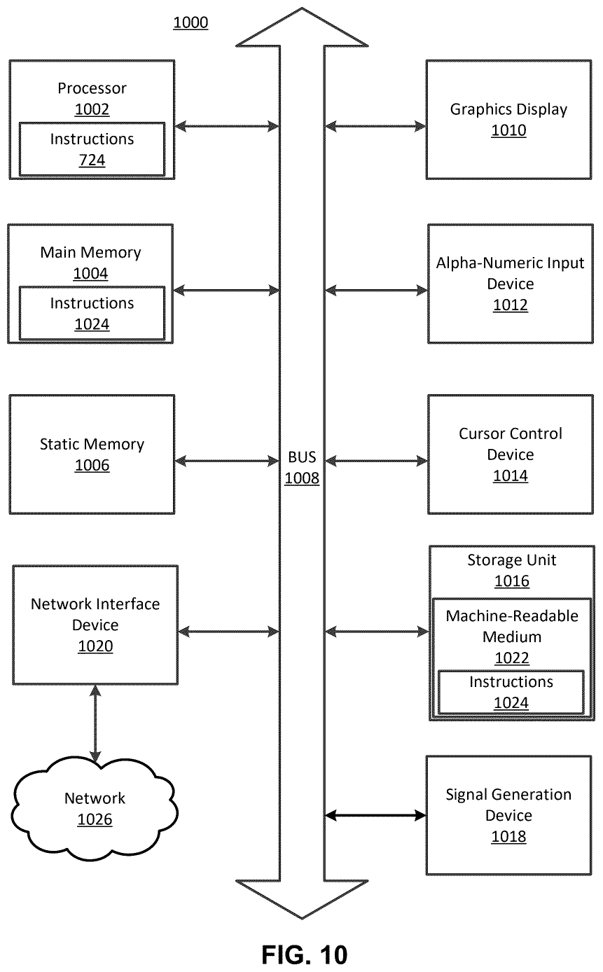

FIG. 10 is a block diagram illustrating components of an example machine for reading and executing instructions from a machine-readable medium, according to an example embodiment. Specifically, FIGS. 1-3 show a diagrammatic representation of computer systems employed throughout the Specification. These systems can be in the example form of a computer system 1000. The computer system 1000 can be used to execute instructions 1024 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes one or more processing units (generally processor 1002). The processor 1002 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 1000 also includes a main memory 1004. The computer system may include a storage unit 1016. The processor 1002, memory 1004, and the storage unit 1016 communicate via a bus 1008.

In addition, the computer system 1000 can include a static memory 1006, a graphics display 1010 (e.g., to drive a plasma display panel (PDP), a liquid crystal display (LCD), or a projector). The computer system 1000 may also include alphanumeric input device 1012 (e.g., a keyboard), a cursor control device 1014 (e.g., a mouse, a trackball, a joystick, a motion sensor, or other pointing instrument), a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. For example, the instructions 1024 may include the functionalities of modules of the systems described in FIG. 1. The instructions 1024 may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 may be transmitted or received over a network 1026 (e.g., network 150) via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

### VI. Additional Considerations

In the description above, for purposes of explanation, numerous specific details are set forth in order to provide a thorough understanding of the illustrated system and its operations. It will be apparent, however, to one skilled in the art that the system may be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B is true (or present).

In addition, the use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for implementing the functionality described herein. Thus, while particular embodiments and applications have been illustrated and described, it is to be understood that the disclosed embodiments are not limited to the precise construction and components disclosed herein. Various modifications, changes, and variations, which will be apparent to those, skilled in the art, may be made in the arrangement, operation, and details of the method and apparatus disclosed herein without departing from the spirit and scope defined in the appended claims.

1. A method for generating a computer code payload in response to receiving a request for a data structure, the method comprising:
receiving, at a network system, a request to generate a computer code package, the request comprising a natural language request for a data structure generated by the computer code package;
accessing a plurality of data segments related to the requested data structure, the plurality of data segments comprising data content used as content input to generate the requested data structure based on a content and a context of the natural language request;
accessing a plurality of computer code templates based on the content and context of the natural language request, each computer code template of the plurality providing a functionality related to generating the requested data structure and adhering to a constraint system of the network system, wherein the constraint system defines security or compliance for code generation in a regulatory environment;
generating a template query vector, the template query vector a representation of the requested data structure, each computer code template, and each data segment based on the content and the context of the natural language request;
applying a model to the template query vector to select a computer code template of the plurality that generates the requested data structure based on the content and context of the natural language request, the plurality of computer code templates, and the plurality of data segments;
generating, using the model applied to the selected computer code template and the plurality of data segments, the computer code payload that generates the requested data structure, wherein the computer code payload, when executed by the network system according to an allocation schema, adheres to the constraint system of the network system; and
executing, on the network system and according to the allocation schema, the computer code payload, when the execution adheres to the constraint system of the network system.

2. The method of claim 1, further comprising:
generating a code query vector, the code query vector a representation of the selected computer code template, the requested data structure, and each data segment; and
wherein generating the computer code payload applies the model to the generated code query vector.

3. The method of claim 1, further comprising:
executing the computer code payload to generate the requested data structure; and
providing the requested data structure to a device requesting the data structure.

4. The method of claim 1, wherein accessing the plurality of computer code templates comprises:
generating a request vector representing functionality of the requested data structure; and
comparing the request vector to vectors representing functionality of computer code templates in a template library; and
selecting, based on a vector comparison, the plurality of computer code templates from computer code templates in the template library having vectors similar to the request vector.

5. The method of claim 1, wherein accessing the plurality of data segments related to the requested data structure comprises:
generating a data request vector representing data used to generate the requested data structure; and
comparing the data request vector to vectors representing data segments in a data segment library; and
selecting, based on a vector comparison, the plurality of data segments from the data segment library having vectors similar to the data request vector.

6. The method of claim 1, further comprising:
accessing the selected computer code template from a template library; and
providing the selected computer code template to the model for generating the computer code payload.

7. The method of claim 1, further comprising:
validating, at the network system, the computer code payload is configured to execute within the constraint system of the network system;
in response to validating the computer code payload, transmitting, to a system executing a selected set of computer resources adhering to the constraint system, the computer code payload for execution;
validating that the generated data structure adheres to the constraint system.

8. The method of claim 7, wherein validating the generated data structure adheres to the constraint system comprises:
instantiating, at the system executing the selected set of computer resources, one or more execution nodes, each of the one or more execution nodes configured to execute computer code while adhering to the constraint system of the network system; and
executing, using the instantiated one or more execution nodes on the selected set of computer resources, the computer code payload to generate the data structure.

9. The method of claim 7, further comprising:
in response to validating the generated data structure, providing, to the network system, the requested data structure.

10. The method of claim 1, further comprising:
generating the allocation schema for executing the computer code payload on the system, the allocation schema defining a selected set of computer resources from a plurality of computer resources on the system for executing the computer code payload.

11. The method of claim 1, wherein generating the computer code payload comprises:
creating a temporary environment to execute the computer code payload, wherein the temporary environment is configured to replicate the constraint system; and
executing the computer code payload in the temporary environment.

12. (canceled)

13. The method of claim 11, wherein the temporary environment isolates the execution from system resources of the network system.

14. The method of claim 1, further comprising:
validating that the generated data structure is the data structure requested by applying a model to compare the generated data structure to the requested data structure.

15. The method of claim 1, wherein the model is a large language model.

16. The method of claim 1, wherein the constraint system defines a set of code libraries usable in the computer code payload to generate the requested data structure.

17. The method of claim 1, wherein the constraint system defines a maximum execution time of the generated computer code payload.

18. The method of claim 1, wherein the constraint system defines a set of system resources usable by the computer code payload to generate the requested data structure.

19. A non-transitory computer readable storage medium storing instructions for generating a computer code payload in response to receiving a request for a data structure, the instructions, when executed by one or more processors, performing steps comprising:
receiving, at a network system, a request to generate a computer code package, the request comprising a natural language request for a data structure generated by the computer code package;
accessing a plurality of data segments related to the requested data structure, the plurality of data segments comprising data content used as content input to generate the requested data structure based on a content and a context of the natural language request;
accessing a plurality of computer code templates based on the content and context of the natural language request, each computer code template of the plurality providing a functionality related to generating the requested data structure and adhering to a constraint system of the network system, wherein the constraint system defines security or compliance for code generation in a regulatory environment;
generating a template query vector, the template query vector a representation of the requested data structure, each computer code template, and each data segment based on the content and the context of the natural language request;
applying a model to the template query vector to select a computer code template of the plurality that generates the requested data structure based on the content and context of the natural language request, the plurality of computer code templates, and the plurality of data segments;
generating, using the model applied to the selected computer code template and the plurality of data segments, the computer code payload that generates the requested data structure, wherein the computer code payload, when executed by the network system according to an allocation schema, adheres to the constraint system of the network system; and
executing, on the network system and according to the allocation schema, the computer code payload, when the execution adheres to the constraint system of the network system.

20. A system comprising:
one or more processors;
a non-transitory computer readable storage medium storing instructions for generating a computer code payload in response to receiving a request for a data structure, the instructions, when executed by the one or more processors, performing steps comprising:
receiving, at a network system, a request to generate a computer code package, the request comprising a natural language request for a data structure generated by the computer code package;
accessing a plurality of data segments related to the requested data structure, the plurality of data segments comprising data content used as content input to generate the requested data structure based on a content and a context of the natural language request;
accessing a plurality of computer code templates based on the content and context of the natural language request, each computer code template of the plurality providing a functionality related to generating the requested data structure and adhering to a constraint system of the network system, wherein the constraint system defines security or compliance for code generation in a regulatory environment;
generating a template query vector, the template query vector a representation of the requested data structure, each computer code template, and each data segment based on the content and the context of the natural language request;
applying a model to the template query vector to select a computer code template of the plurality that generates the requested data structure based on the content and context of the natural language request, the plurality of computer code templates, and the plurality of data segments;
generating, using the model applied to the selected computer code template and the plurality of data segments, the computer code payload that generates the requested data structure, wherein the computer code payload, when executed by the network system according to an allocation schema, adheres to the constraint system of the network system; and
executing, on the network system and according to the allocation schema, the computer code payload, when the execution adheres to the constraint system of the network system.

21. (canceled)
